(19) United States
(12) Patent Application Publication
(10) Pub. No.: US 2017/0025802 A1
(43) Pub. Date: Jan. 26, 2017

(54) MODULAR CONNECTOR SYSTEM

(71) Applicant: Honeywell International Inc., Morristown, NJ (US)

(72) Inventors: Shi Mei Deng, Shanghai (CN); Denny Liu, Shanghai (CN); Sam Chen, Shanghai (CN); Chris Jiang, Shanghai (CN)

(73) Assignee: Honeywell International Inc.

(21) Appl. No.: 14/804,666

(22) Filed: Jul. 21, 2015

(51) Int. Cl. H01R 24/64; H01R 43/16; H01R 13/66; H01R 27/02

(52) U.S. Cl. CPC H01R 24/64; H01R 27/02; H01R 43/16; H01R 13/6633; H01R 13/665; H01R 2107/00

(57) ABSTRACT

An electrical communications system includes a communications cable that couples electrical communications between a first device, a second device, and a third device, the communications cable having a group of root wires that electronically and modularly connects to the third device to permit electronic communication with the third device and allow communications and signaling between the first, second, and third devices without the functionalities of each the first, second, and third devices detrimentally affecting one another.

### TECHNICAL FIELD

Embodiments are related to interfaces and, more particularly to, interfaces/connectors for coupling different types of data between, wherein, for example, one type of data requires a higher data rate than the other type of data. Embodiments are also related to modular connectors and Ethernet components and electronic communications thereof.

### BACKGROUND

Modular connectors are electrical connectors that were originally designed for use in telephone wiring, but has since been used for many other purposes. Many applications that originally used a bulkier, more expensive connector have converted to modular connectors. Probably the most well-known applications of modular connectors are for telephone jacks and for Ethernet jacks, both of which are nearly always modular connectors.

Such modular connectors or interface connectors are typically very limited due to the nature of the product setup, mechanical design, and so on. Adding one or more connectors also increases the overall costs. To save on costs, special connectors such as, for example, RJ45 connectors can be reused, particularly when needed for two or more functions. One of the problems with reusing such connectors, however, is that their functionality may be affected by other functions and components.

FIG. 1 illustrates a block diagram of a prior art electronic communications system 10 in which a first device 12 communicates electronically with a second device 20 via an Ethernet cable. In the configuration depicted in FIG. 1, the system 10 includes a first device that communicates with a second device via an Ethernet cable 19. The first device 12 includes an Ethernet MAC physical layer 14 that communicates with an isolation transformer 16, which in turn communicates with an RJ45 connector 18. The second device 20 includes an RJ45 connector 22 that communicates with an isolation transformer 24, which in turn communicates with an Ethernet MAC physical layer 26. The Ethernet MAC physical layer 14 is implemented as a 10/100M Ethernet component that communicates with another 10/100M Ethernet component (i.e., the Ethernet MAC physical layer 26) using a standard RJ45 connector and a standard Ethernet cable. Note that in some implementations, RJ45 connector pins 4, 5, 7, and 8 are used for PoE (Power over Ethernet) applications or 1000M Ethernet generally. Thus, the RJ45 connector would not be used in 10/100M Ethernet applications.

FIG. 2 illustrates a block diagram of a prior art electronic communications system 30 in which a first device 32 communicates electronically with a second device 38 via a 4 core cable 37. The first device 32 shown in FIG. 2 includes an RS485 or RS422 component 34 that communicates with a connector 36. The second device 38 includes a connector 40 that communicates with an RS485 or RS422 component 42. Thus, the configuration of system 30 allows an RS485 or RS422 component to communicate with another RS485 or RS422 component by using a 2 or 4 pin connector (which is generally not a standard part). Thus, two connectors and cables for Ethernet and RS422 and RS485 communications are required with such an arrangement.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved interfaces for coupling different types of data.

It is another aspect of the disclosed embodiments to provide for improved modular connectors and Ethernet components and electronic communications thereof.

It is yet another aspect of the disclosed embodiments to provide a modular communications system that enables Ethernet communications with RS485 and/or RS422 interface electrical components and the reuse of RJ45 interface electrical components.

The aforementioned aspects and other objectives and advantages can now be achieved as described herein. An electrical communications system is disclosed which includes a communications cable that couples electrical communications between at least a first device, a second device, and a third device, the communications cable having a group of root wires that electronically and modularly connects to the third device to permit electronic communication with the third device and allow communications and signaling between the first, second, and third devices without the functionalities of each the first, second, and third devices detrimentally affecting one another.

In one embodiment, the communications cable constitutes an Ethernet cable. In some embodiments, first device includes an RJ45 interface, an isolated RS485/422 electronic integrated circuit, and an Ethernet physical layer, wherein the isolated RS485/422 electronic integrated circuit and the Ethernet physical layer communicate electronically with the communications cable through the RJ45 interface. The second device can include an RJ45 interface associated with a transformer and an Ethernet physical layer that communicates electronically with the communications cable through the RJ45 interface. The third device includes one or more devices, where each such device includes an isolated RS485/422 electronic integrated circuit and a connector, wherein the isolated RS485/422 electronic integrated circuit communicates electronically with the communications cable through the pin connector. Additionally, the pin connector includes or encompasses the group of root wires.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a prior art electronic communications configuration in which a first device communicates electronically with a second device via an Ethernet cable;

FIG. 2 illustrates a block diagram of a prior art electronic communications configuration in which a first device communicates electronically with a second device via a 4 core cable;

FIG. 3 illustrates a block diagram of an improved electronic communications system in which a first device communicates electronically with second and third devices, in accordance with a preferred embodiment;

FIG. 4 illustrates a schematic diagram of an electronic communications system in which a first device communicates electronically with second and third devices, in accordance with an alternative embodiment;

FIG. 5 illustrates a schematic diagram of an electronic communications system in which a first device communicates electronically with second and third devices, in accordance with an alternative embodiment; and

FIG. 6 illustrates a pictorial image of a cabling arrangement for connecting first, second, and third devices including the use of a pin connector for connecting to the third device, in accordance with an alternative embodiment.

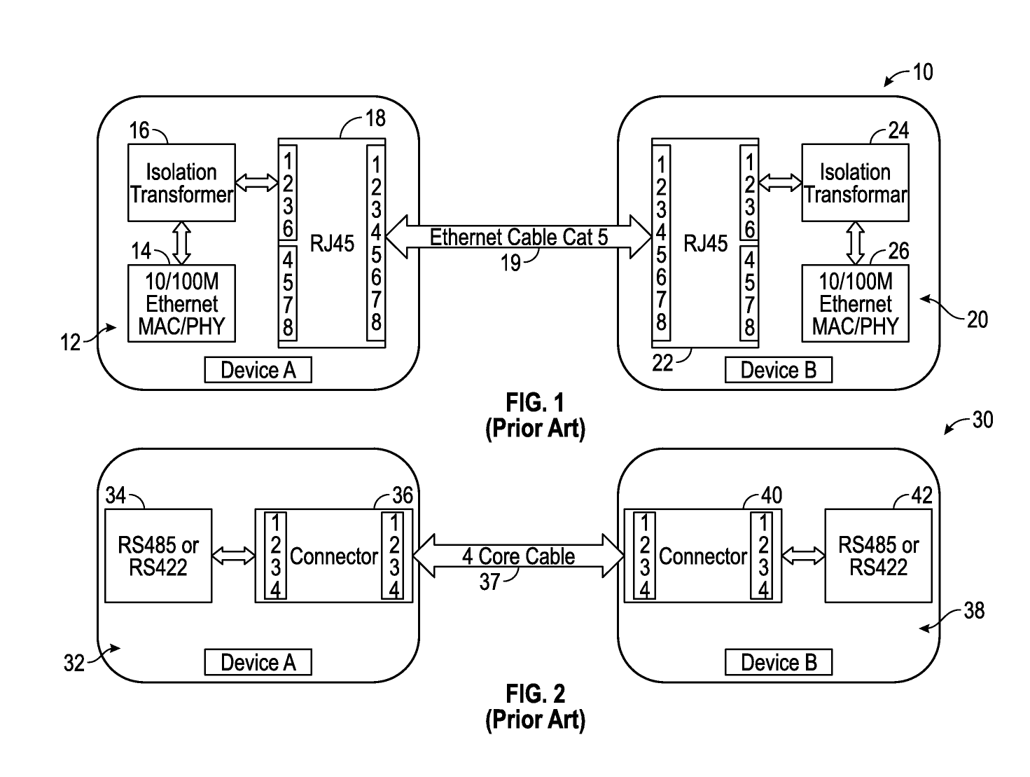

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. As used herein, the term “and/or” includes any and all combinations of one or more of the associated listed items.

Reference will be made in detail to the disclosed embodiments exemplary embodiments) of the invention, examples of which are illustrated in the accompanying drawings, and which may be preferred or alternative embodiments. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”. “with”, or variants thereof are used in either the detailed description and the claims, such terms are intended to be inclusive in a manner similar to the term “comprising.” The term at least one or is used to mean one or more of the listed items can be selected.

Note that as utilized herein the term “RS485” (also known at RS-485) refers to a serial data transfer protocol that is an Electronics Industry Alliance (EIA) standard for multipoint communications. “RS422” (also known as RS-422 or TIA/EIA-422) as utilized herein refers to an EIA technical standard that specifies electrical characteristics of a digital signaling circuit. “RJ45” as utilized herein refers to “Registered Jack-45,” an eight-wire connector used commonly to connect computers to, for example, a LAN (Local Area Network) and, in particular, Ethernet connections. The RJ-45 connector looks similar to the ubiquitous RJ-11 connectors used for connecting telephone equipment, but they are somewhat wider.

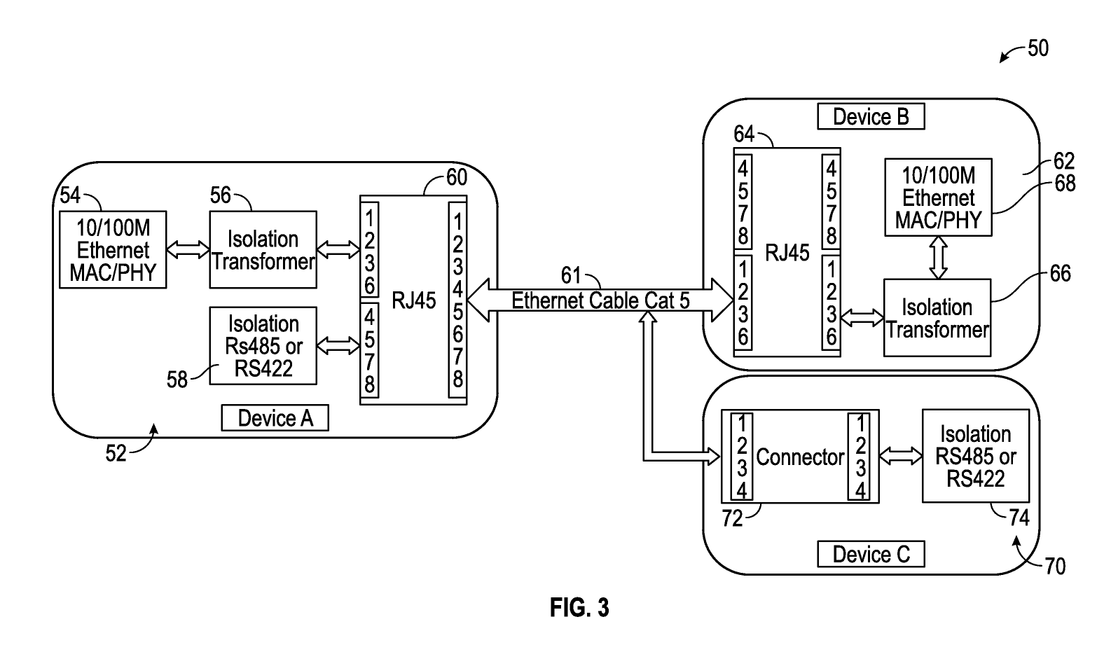

FIG. 3 illustrates a block diagram of an improved electronic communications system 50 in which a first device 52 communicates electronically with respective second and third devices 62 and 70, in accordance with a preferred embodiment. The first device includes an Ethernet MAC Physical Layer 54 (e.g., 10/100 M Ethernet MAC/PHY) that communicates bidirectionally with an isolation transformer 56. The isolation transformer 56 communicates bidirectionally with an RJ45 connector/component (interface) 60, which in turn communicates and connects to an Ethernet cable 61. The first device 52 further includes an isolation RS485 or RS422 electronic integrated circuit 58, which in turn communicates bidirectionally with the RJ45 connector/interface 60.

The second device 62 includes an Ethernet MAC Physical Layer 68 that communicates bidirectionally with an isolation transformer 66 that in turn communicates bidirectionally with an RJ45 connector/component (interface) 64 that is connected to and communicates with the Ethernet cable 61. The third device 70 includes an isolation RS485 or RS422 electronic integrated circuit 74 that communicates electronically with a connector 72, which in turn communicates bidirectionally with the Ethernet cable 61. Note that in some embodiments, the connector 72 may be implemented as, for example, a connecting component with 8 roots. It can be appreciated, of course, that such a number of roots is discussed herein for exemplary purposes only and is not considered a limiting feature of the disclosed embodiments.

Thus, in some embodiments, the first device 52 can be implemented as a special product with an RJ45 component having at least pins 4, 5, 7, and 8 used for RS485 or RS422 components. The second device 62 can be implemented in some embodiments with off the shelf or “standard” components. The third device 70 can be implemented as an RS485 or RS422 “standard” product. The system 50 shown in FIG. 3 does not consider whether, for example, the pins 4, 5, 7, and 8 of the RJ45 of the second device 62 is used for normal functionalities because the cable 61 does not connect these signals from the first device 52 to the second device 62.

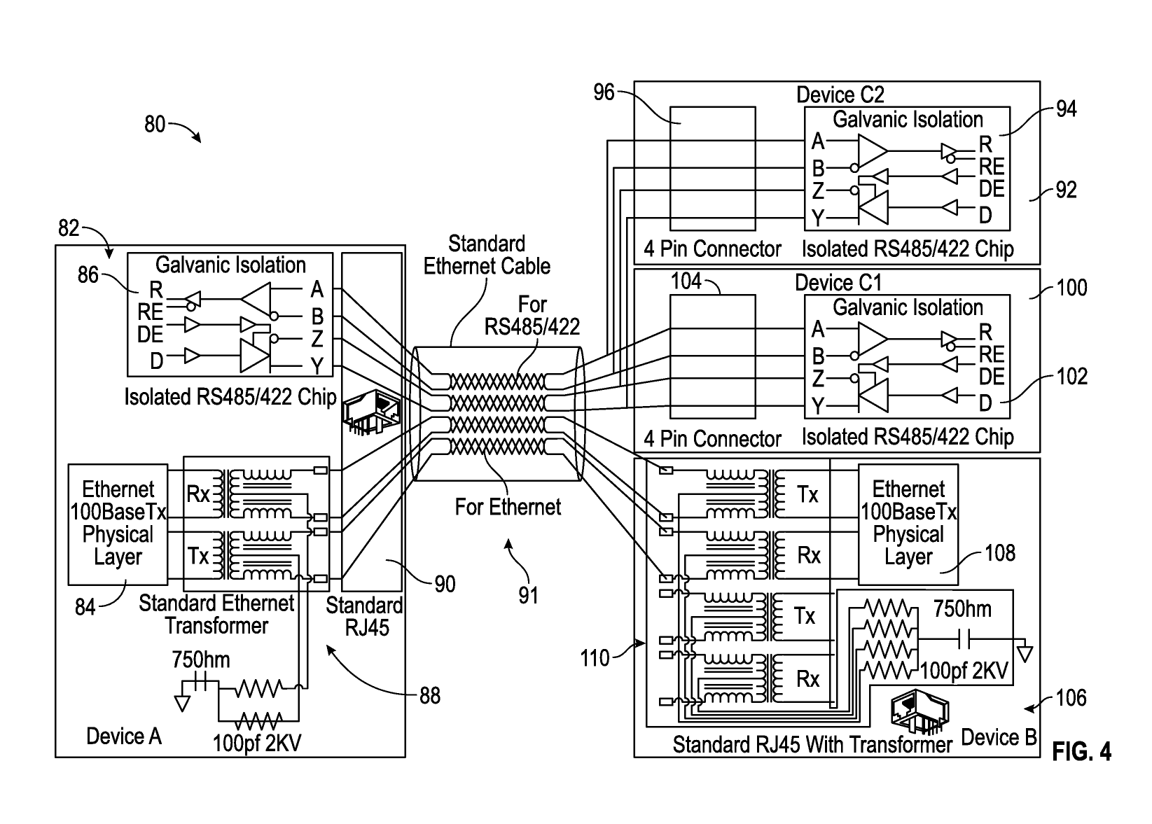

FIG. 4 illustrates a schematic diagram of an electronic communications system 80 in which a first device communicates electronically with second and third devices, in accordance with an alternative embodiment. Note that the alternative embodiment of system 80 is similar to the embodiment of system 50 depicted in FIG. 3, with some variations. For example, instead of a single third device such as the third device 70 depicted in system 50 of FIG. 3, the third device can be composed of multiple such devices, which will be discussed in greater detail shortly.

System 80 of FIG. 4 thus includes a first device 82, a second device 106, and third devices 92 and 100. The first device 82 is composed of an Ethernet physical layer 84 (e.g., Ethernet 100BaseTx Physical Layer), which communicates electronically with a Ethernet transformer circuit 88. The first device 82 further includes an isolated RS485/RS422 chip (integrated circuit) 86 that communicates via an RJ45 connector/interface 90 with an Ethernet cable 91. The transformer circuit 88 also communicates via the RJ45 connector interface 90 with the Ethernet cable 91. The Ethernet cable 91 can be implemented as an Ethernet cable for RS485/RS422. The second device 106 includes an Ethernet Physical Layer 108 (e.g., Ethernet 100BaseTx Physical Layer) that is connected to and communicates electronically with an RJ45 connector/interface (with transformer) 110, which in turn is connected electronically to the Ethernet cable 91. The third devices 92 and 100 each have similar components to one another. For example, the third device 92 includes a 4-pin connector 96 and an isolated RS485/422 integrated circuit (chip) 94. The third device 100 includes a 4-pin connector 104 that is connected to an isolated RS485/422 integrated circuit (chip) 102. The 4-pin connectors 96 and 104 connect to the Ethernet cable 91

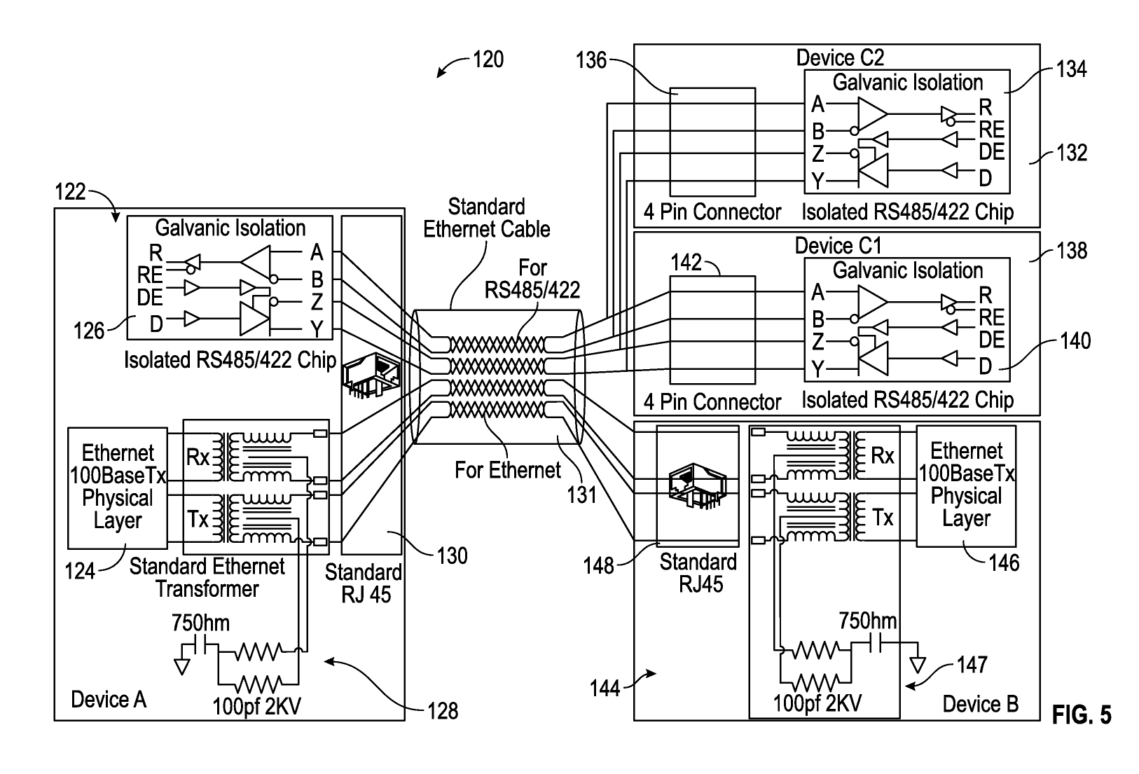

FIG. 5 illustrates a schematic diagram of an electronic communications system 120 in which a first device 122 communicates electronically with a second device 144 and third devices 132, 138, in accordance with an alternative embodiment. The system 120 of FIG. 5 is similar to the system 80 of FIG. 4, but with some variations. The first device 122 includes an Ethernet Physical Layer 124 (e.g., Ethernet 100BaseTx Physical Layer) that is connected to an Ethernet transformer circuit 128, which in turn communicates electronically with an Ethernet cable 131 via connection to an RJ45 connector 130. The first device 122 further includes an isolated RS485/422 chip 126 that also communicates electronically with the Ethernet cable 131 via connection to the RJ45 connector 130.

The second device 144 includes an Ethernet Physical Layer 146 (e.g., Ethernet 100BaseTx Physical Layer) connected to a transformer circuit 147 that in turn is connected to an RJ45 connector/interface 148 that connects to the Ethernet cable 131. The third devices 132 and 138 are similar to one another. For example, the third device 132 includes an isolated RS485/RS422 integrated circuit (chip) 134 that connects to a 4-pin connector 136, which in turn connects to the Ethernet cable 131. The third device 138 includes an isolated RS485/RS422 integrated circuit (chip) 140 that connects to a 4-pin connector 142, which in turn connects to the Ethernet cable 131.

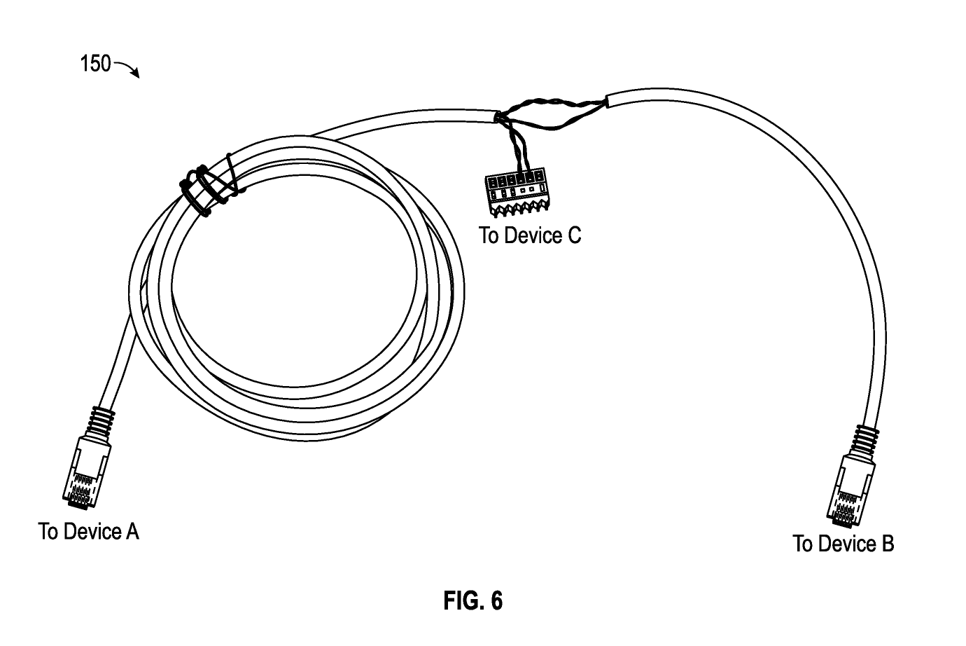

FIG. 6 illustrates a pictorial image of a cabling arrangement 150 for connecting first, second, and third devices including the use of a pin connector for connecting to the third device, in accordance with an alternative embodiment. The cabling arrangement 150 thus includes one end connected to a first device (e.g., device A), which has 8 root wires that connect with the other two ends. One end connects to the third device (device C). One end is also connected to the second device (device B).

Based on the foregoing, it can be appreciated that a number of embodiments, alternative and preferred, are disclosed herein. For example, in one embodiment, an electrical communications system is disclosed, which can include a communications cable that couples electrical communications between at least a first device, a second device, and a third device, the communications cable having a group of root wires that electronically and modularly connects to the third device to permit electronic communication with the third device and allow communications and signaling between the first, second, and third devices without the functionalities of each the first, second, and third devices detrimentally affecting one another. In some embodiments, the communications cable comprises an Ethernet cable.

In another embodiment, the first device can include an RJ45 interface, an isolated RS485/422 electronic integrated circuit, and an Ethernet physical layer, wherein the isolated RS485/422 electronic integrated circuit and the Ethernet physical layer communicate electronically with the communications cable through the RJ45 interface. In still another embodiment, the second device can include an RJ45 interface associated with a transformer and an Ethernet physical layer that communicates electronically with the communications cable through the RJ45 interface. In yet another embodiment, the third device can include at least one device that includes at least one isolated RS485/422 electronic integrated circuit and at least one pin connector, wherein the isolated RS485/422 electronic integrated circuit communicates electronically with the communications cable through the pin connector.

In yet another embodiment, a method of electrical communications can be implemented, which includes steps or operations for electrically coupling a communications cable between at least a first device, a second device, and a third device, the communications cable facilitating electrical communications between the first device, the second device, and the third device; and providing the communications cable with a group of root wires that electronically and modularly connects to the third device to permit electronic communication with the third device and allow communications and signaling between the first, second, and third devices without the functionalities of each the first, second, and third devices detrimentally affecting one another.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An electrical communications system, comprising:
a communications cable that couples electrical communications between at least a first device, a second device, and a third device, said communications cable having a plurality of root wires that electronically and modularly connects to said third device to permit electronic communication with said third device and allow communications and signaling between said first, second, and third devices without the functionalities of each said first, second, and third devices detrimentally affecting one another.

2. The system of claim 1 wherein said communications cable comprises an Ethernet cable.

3. The system of claim 1 wherein said first device comprises an RJ45 interface, an isolated RS485/422 electronic integrated circuit, and an Ethernet physical layer, wherein said isolated RS485/422 electronic integrated circuit and said Ethernet physical layer communicate electronically with said communications cable through said RJ45 interface.

4. The system of claim 1 wherein said second device comprises an RJ45 interface associated with a transformer and an Ethernet physical layer that communicates electronically with said communications cable through said RJ45 interface.

5. The system of claim 1 wherein said third device comprises at least one device comprising at least one isolated RS485/422 electronic integrated circuit and at least one pin connector, wherein said at least one isolated RS485/422 electronic integrated circuit communicates electronically with said communications cable through said pin at least one pin connector.

6. The system of claim 5 wherein said at least one pin connector comprises said plurality of root wires.

7. The system of claim 3 wherein said second device comprises an RJ45 interface associated with a transformer and an Ethernet physical layer that communicates electronically with said communications cable through said RJ45 interface.

8. The system of claim 3 wherein said third device comprises at least one device comprising at least one isolated RS485/422 electronic integrated circuit and at least one pin connector, wherein said at least one isolated RS485/422 electronic integrated circuit communicates electronically with said communications cable through said pin at least one pin connector.

9. The system of claim 8 wherein said communications cable comprises an Ethernet cable.

10. The system of claim 8 wherein said at least one pin connector comprises said plurality of root wires.

11. The system of claim 2 wherein said first device comprises an RJ45 interface, an isolated RS485/422 electronic integrated circuit, and an Ethernet physical layer, wherein said isolated RS485/422 electronic integrated circuit and said Ethernet physical layer communicate electronically with said communications cable through said RJ45 interface.

12. The system of claim 2 wherein said second device comprises an RJ45 interface associated with a transformer and an Ethernet physical layer that communicates electronically with said communications cable through said RJ45 interface.

13. The system of claim 2 wherein said third device comprises at least one device comprising at least one isolated RS485/422 electronic integrated circuit and at least one pin connector, wherein said at least one isolated RS485/422 electronic integrated circuit communicates electronically with said communications cable through said pin at least one pin connector.

14. An electrical communications system, comprising:
a communications cable that couples electrical communications between at least a first device, a second device, and a third device, said communications cable having a plurality of root wires that electronically and modularly connects to said third device to permit electronic communication with said third device and allow communications and signaling between said first, second, and third devices without the functionalities of each said first, second, and third devices detrimentally affecting one another;
an Ethernet cable, wherein said communications cable comprises said Ethernet cable; and
said at least one pin connector comprising said plurality of root wires.

15. The system of claim 14 wherein said first device comprises an RJ45 interface, an isolated RS485/422 electronic integrated circuit, and an Ethernet physical layer, wherein said isolated RS485/422 electronic integrated circuit and said Ethernet physical layer communicate electronically with said communications cable through said RJ45 interface.

16. The system of claim 15 wherein said second device comprises an RJ45 interface associated with a transformer and an Ethernet physical layer that communicates electronically with said communications cable through said RJ45 interface.

17. The system of claim 15 wherein said third device comprises at least one device comprising at least one isolated RS485/422 electronic integrated circuit and at least one pin connector, wherein said at least one isolated RS485/422 electronic integrated circuit communicates electronically with said communications cable through said pin at least one pin connector.

18. A method of electrical communications, said method comprising:
electrically coupling a communications cable between at least a first device, a second device, and a third device, said communications cable facilitating electrical communications between said first device, said second device, and said third device;
providing said communications cable with a plurality of root wires that electronically and modularly connects to said third device to permit electronic communication with said third device and allow communications and signaling between said first, second, and third devices without the functionalities of each said first, second, and third devices detrimentally affecting one another.

19. The method of claim 18 wherein:
said first device comprises an RJ45 interface, an isolated RS485/422 electronic integrated circuit, and an Ethernet physical layer, wherein said isolated RS485/422 electronic integrated circuit and said Ethernet physical layer communicate electronically with said communications cable through said RJ45 interface; and
said second device comprises an RJ45 interface associated with a transformer and an Ethernet physical layer that communicates electronically with said communications cable through said RJ45 interface.

20. The method of claim 19 wherein said third device comprises at least one device comprising at least one isolated RS485/422 electronic integrated circuit and at least one pin connector, wherein said at least one isolated RS485/422 electronic integrated circuit communicates electronically with said communications cable through said pin at least one pin connector.
